(19) United States
(12) Patent Application Publication
(10) Pub. No.: US 2006/0165582 A1
(43) Pub. Date: Jul. 27, 2006

(54) Production of synthesis gas

(76) Inventors: Donald Duane Brooker, Kingsport, TN (US); Joseph Nathaniel Bays, Kingsport, TN (US)

Correspondence Address: Jonathan D. Wood;Eastman Chemical Company, P.O. Box 511, Kingsport, TN, 37662, US

(21) Appl. No.: 11/044,144

(22) Filed: Jan. 27, 2005

(51) Int. Cl. C01B 31/00

(52) U.S. Cl. 423/414

(57) ABSTRACT

Disclosed are gasification processes for the production of mixtures of carbon monoxide and hydrogen, by the partial oxidation of a carbonaceous feedstock material wherein carbon values contained in a solid slag effluent from the partial oxidation reactor are recovered and recycled to the gasification reactor.

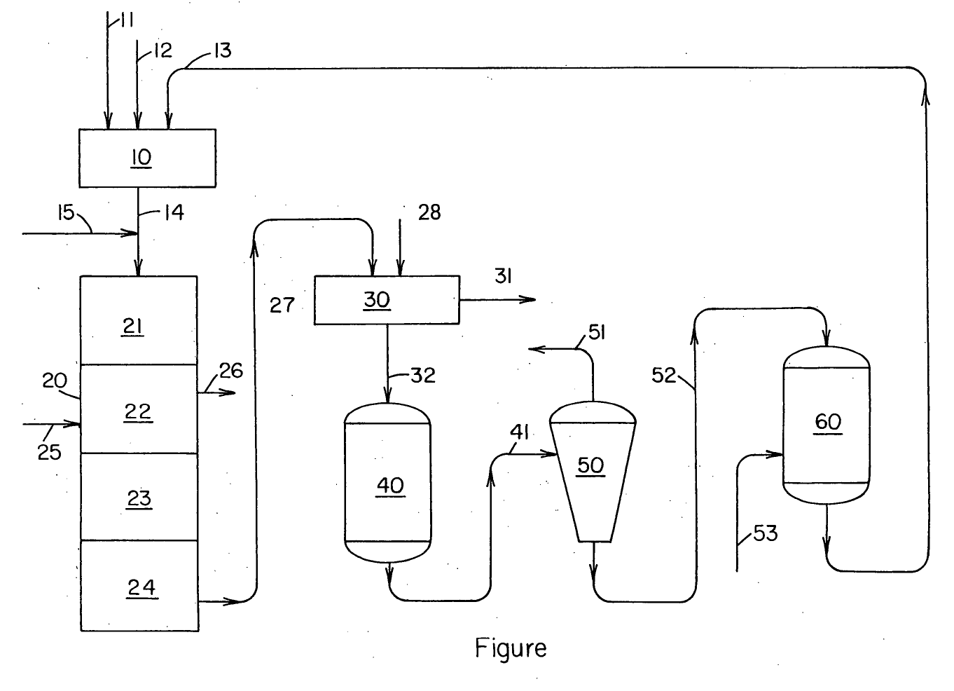

### FIELD OF THE INVENTION

This invention pertains to gasification processes for the production of mixtures of carbon monoxide and hydrogen, by the partial oxidation of a carbonaceous feedstock material. More specifically, the present invention pertains to a process for the production of carbon monoxide and hydrogen wherein carbon values contained in a solid slag effluent from the partial oxidation reactor are recovered and recycled to the gasification reactor.

### BACKGROUND OF THE INVENTION

Gasification is among the cleanest and most efficient technologies for the production of power, chemicals and industrial gases from carbonaceous or hydrocarbon feedstocks, such as coal, heavy oil, and petroleum coke. Gasification converts hydrocarbon feedstocks into clean synthesis gas, or syngas, composed primarily of hydrogen (H₂) and carbon monoxide (CO). Syngas is a feedstock for making a host of useful organic compounds or can be used as a clean fuel to produce power by an environmentally-acceptable means. In a gasification plant, a carbonaceous or hydrocarbon feedstock and molecular oxygen (O₂) are contacted at high temperatures and pressures within a partial oxidation reactor (gasifier). The feedstock and molecular oxygen react and form syngas. Non-gasifiable ash material forms a molten slag as a by-product effluent. Along with the ash unconverted and/or incompletely converted feedstock will also be generated in the reactor chamber. Hot syngas exiting the gasifier is cooled either by direct contact with water in a quench chamber, or indirectly in a syngas cooler to recover excess heat/energy. The molten slag and unconverted carbon effluent is contacted with water and rapidly cooled and solidified into irregularly-shaped particles of varying size in a quench chamber. The quench chamber may serve not only to cool and saturate the syngas, but also to disengage slag particles from the syngas, capturing the slag and unconverted carbon particles in the quench water. The finer slag and unconverted carbon particles can be carried through the process and be removed further downstream with the syngas.

In addition to H₂ and CO, the gaseous effluent from the gasifier contains small quantities of other gases such as carbon dioxide (CO₂), water, ammonia, methane, hydrogen sulfide (H₂S), carbonyl sulfide (COS), nitrogen, and argon. As much as 99 percent or more of the H₂S and COS present in the gaseous effluent can be recovered and converted to elemental sulfur for use in the fertilizer or chemical industries. The clean syngas then is used for generating electricity and producing industrial chemicals and gases.

Most of the ash present in the solid feedstock and some unconverted and/or incompletely converted feedstock is removed from the gasifier as solid slag effluent particles through a water-sealed, depressurizing lockhopper system. The lockhopper, e.g., the apparatus described in U.S. Pat. No. 6,706,199-B2, typically is a cylindrical vessel vertically oriented with top and bottom valves. This vessel is located directly beneath the gasifier quench chamber or syngas cooler sump. The conventional lockhopper cycles through collection and dump modes. In the collection mode the top valve, the lockhopper inlet, is open to the gasifier, and the bottom valve, the lockhopper outlet, is closed. The entire lockhopper is filled with water forming a continuous column of water with the quench water, in the quench chamber mode, or with the syngas cooler sump water, in the syngas cooler mode. Thus, during the collection mode, slag entering either the quench chamber or the syngas cooler sump is able to drift unhindered downwards through the lockhopper inlet valve and into the lockhopper vessel.

Typical gasification processes, e.g., the processes described in U.S. Pat. No. 5,338,489-B1 and U.S. Pat. No. 6,706,1 99-B2, produce a slag effluent containing up to 20 weight percent unconverted carbon based on the carbon content of the feedstock material. For example, a typical coal gasification process converts 92-99 weight percent of the coal feedstock entering the gasifier. To generate additional CO and protect the refractory, optimal conversion rates can drop as low as approximately 88 weight percent. The use of petroleum coke as the feedstock would result in a conversion lower than coal for single pass operations in order to control the gasifier CO composition. The unconverted carbon is mixed with and becomes a component of the slag effluent and exits the gasifier through the lockhopper. The lockhopper dumps the heavier slag effluent from the gasification process into a cement sump or pad. The mixture of slag effluent and water then is removed from the sump by a slag drag conveyor or front end loader. The unconverted or incompletely converted carbonaceous or hydrocarbon feedstock may exist at a ratio of about 1 to 2 to the ash content of the slag, increasing the amount of the slag which must be handled and disposed of, typically in a landfill. Furthermore, the loss of unconverted or incompletely converted carbonaceous or hydrocarbon feedstock in the slag effluent represents a significant economic loss in the cost of feedstock.

JP 2001-214178-A describes a method of recovering unburned carbon from the gasification of a solid fuel using a combination of two wet type cyclone separators. While some separation of the ash and unconverted carbon is being conducted by this process, the process is conducted under pressure, requires cooling of the water, and may not achieve optimal slag/unconverted carbon separation. As gasifier pressure and quench water temperature increases, placing the separation devices in the stated location can effect gasification reliability. JP-1993-337442-A describes a method for the recovery of unburned carbon from fly ash produced from the burning of coal. EP-19641-B discloses the recovery of carbon from synthesis gas scrubbing liquors. U.S. Pat. No. 4,255,378-B discloses a partial oxidation process including separation of particles high in carbon content from particles low in carbon content suspended in water used for quenching or scrubbing the gaseous products of the partial oxidation of a solid, ash-containing, carbonaceous fuel. U.S. Pat. No. 4,424,065-B discloses a method of particulate-carbon recovery from the product gas in a coal gasification process of the type using water-carbon slurry combusted with oxygen in a reactor using water scrubbing for the product gas to obtain particulate carbon together with ash. Certain ash content is trapped in carbon particles which have a tendency of lumping together. The carbon and ash fraction is treated with liquid hydrocarbon for carbon particle wetting and facilitating separation of ash. The recovered carbon is ground to break down larger carbon particles and sent through a wet-particle separator Carbon particles which pass a predetermined mesh size, e.g., approximately 63 micron mesh, are sent back to the reactor for mixing with the water-carbon slurry inlet for further combustion. The larger fractions of carbon are either ground down to size again, or diverted for other uses. Recycling carbon particles which pass a 63 micron mesh and are almost devoid of ash improves the carbon utilization and significantly reduces total ash formed. The abrasion damage on components because of ash is also reduced.

It is known that the ash particles may be separated from the finer carbon material by means of simple screening and washing the carbon-containing slag/aggregate. Recycling the fines recovered from the ash settler or clarifier back to the gasifier also is known. The lockhopper has been employed as a gravity settler during the operations of a gasification plant to provide a carbon-rich stream for recycling. Charah Environmental presented a paper in 2003 describing the recovery of carbon values in an electrical generation plant that employs a gasifier in conjunction with a convention steam generator. The recovery method includes the steps of: (1) transferring a dry gasifier effluent feed from the pile to a conveyor belt, (2) mixing the dry effluent with water in a mixing tank, (3) pumping the material from the bottom of the tank to a vibrating screen and separating the ash aggregate out, (4) transferring the underflow from the screen to a separation device wherein the material is split into a −0.20/+100 mesh stream and a −100 mesh stream, (5) using a settler and filter press to further dewater the −100 mesh stream, and (6) transferring the three materials partitioned into holding bins for removal by a front end loader. None of this material is recycled to the gasifier.

### BRIEF SUMMARY OF THE INVENTION

We have developed a process that utilizes slag effluent obtained from the lockhopper sump of a partial oxidation reactor and separates unconverted carbon from the slag effluent. The recovered carbon is recycled to the partial oxidation reactor directly or via the grinding mill wherein fresh carbonaceous feedstock is ground and mixed with water to form a slurry of feedstock and recovered carbon values that is fed to the partial oxidation reactor. The present invention thus provides a process for the recovery of carbon values from the solid effluent obtained from a gasification process wherein a carbonaceous fuel is partially oxidized in a gasification zone at elevated temperature and pressure operated in the slagging mode to produce (i) a gaseous product stream comprising carbon monoxide and hydrogen, and (ii) a solid slag effluent comprising ash and unconverted carbon, which recovery process comprises the step of:
(1) feeding a slurry of the solid effluent, obtained directly from the gasification process, in water to a vibrating screen device designed and operated to produce a first solid product having an average particle size of greater than about 850 microns and a water slurry of a second solid product having an average particle size of less than about 850 microns;
(2) feeding the water slurry of the second solid product produced in step (1) to a separation device to produce (1) a water slurry stream of solids comprising particles having an average particle size of less than about 150 microns and (2) a water slurry stream of solids comprising particles having an average particle size of about 150 to 850 microns; and
(3) feeding water slurry stream (2) produced in step (2) to the gasification zone. Our novel process increases the efficiency of the gasification process, decreases feedstock consumption by up to 10%, and eliminates the use of expensive solid handling equipment such as front end loaders or slag drag conveyors, without causing operation swings that are detrimental to syngas production.

### BRIEF DESCRIPTION OF THE DRAWING

The accompanying FIGURE is a process flow diagram illustrating a system embodying the principles of the present invention. While the invention is susceptible to embodiment in various forms, there is shown in the accompanying FIGURE and hereinafter described in detail a preferred embodiment of the invention.

### DETAILED DESCRIPTION

The present invention provides a means for increasing the efficiency of partial oxidation or gasification processes without impacting reliability. Partial oxidation reactions generally involve reacting organic compounds with oxygen under conditions which favor the formation of partially, as opposed to fully, oxidized material. As noted above, partial oxidation can be used to make syngas, which is a mixture of hydrogen and carbon monoxide. Partial oxidation also is commonly called gasification since typically liquid and/or solid feedstock is used to make hydrogen and carbon monoxide gases.

The partial oxidation feedstock is one or more materials containing hydrogen and carbon. Generally, the feedstock is one or more organic compounds which provide a source of hydrogen and carbon for the partial oxidation reaction. Fluid hydrocarbonaceous fuel, meaning a composition comprised of one or more compounds of hydrogen and carbon in a fluid state, can be used as feedstock. The fluid can be either gaseous, liquid or fluidized solid. Typical fluid hydrocarbonaceous fuels include, among others, one or mixtures of the following: petroleum products, including distillates and residues, such as crude petroleum, reduced crude, gasoline, naphtha, kerosine, crude petroleum asphalt, gas oil, residual oil, tar sand oil, shale oil, cycle gas oil, tire oil, oil derived from coal, lignite, aromatic hydrocarbons (such as benzene, toluene, and xylene fractions), coal tar, furfural extract of coke or gas oil; oxygenated hydrocarbonaceous organic materials including carbohydrates, cellulosics, aldehydes, organic acids, alcohols, ketones, oxygenated fuel oil; waste liquid and by-products from chemical processes containing oxygenated hydrocarbonaceous organic materials; gaseous hydrocarbons and mixtures, including natural gas, refinery off gases or other gas streams containing hydrogen and/or saturated or unsaturated hydrocarbons like methane, ethane, ethene, propane, propene, and so on; waste gases including organic nitrogen, sulfur or oxygen compounds; and similar materials. Another feedstock is solid carbonaceous material, meaning a composition comprised of one or more solid compounds of carbon. Typical solid carbonaceous material includes, among others, one or mixtures of the following: coal, such as anthracite, bituminous, subbituminous; coke from coal; lignite, residue derived from coal liquefication; petroleum residues (resid) resulting from petroleum distillation and cracking processes; oil shale; tar sand; petroleum coke; asphalt; pitch; particulate carbon (soot); concentrated sewage sludge; tank and pond bottoms; separator sludge; air flotation solids; and similar materials. Preferred feedstocks include coal and low grade by-products of heavy crude oil refining, especially coke and residual oils.

Carbonaceous or other material which is solid at ambient temperature can be fluidized in any appropriate manner. In the case of some pitches, asphalt, and tar sand, it may be possible to use them as liquids by heating them to temperatures up to their decomposition temperature. Feedstock containing large amounts of water can be pre-dried to a moisture content suitable to facilitate grinding and/or slurrying, such as from about 2 to about 20 weight percent water, depending on the nature of the feedstock. Solid carbonaceous material is generally provided in particulate form such as by grinding, preferably to a particle size which passes through an ASTM E11-70 Sieve Designation Standard (SDS) 1.4 mm Alternative No. 14, e.g., an average particle size of about 0.1 mm. A suspending medium, such as a slurrying agent, in which the solid feedstock is suspended or entrained may be used. The suspending medium may be any material(s) effective for fluidizing solid feedstock. Typical suspending media include, among others, one of more of the following: water; liquid hydrocarbonaceous material including oxygen-, sulfur- or nitrogen-containing organic liquids; carbon dioxide; steam; nitrogen; recycle synthesis gas; and similar materials. The solids content of the feedstock in suspending medium may be any effective amount, typically ranging from about 5 to 80, preferably from about 45 to 70, weight percent, depending upon the characteristics of the solid and the suspending medium. The solid carbonaceous material preferably is provided as a pumpable slurry in a suspending medium. Typically, ground solid carbonaceous or other material is slurried with a suspending medium in a slurry preparation tank, where the slurry is prepared to a desired concentration, and thereafter pumped to the partial oxidation reactor by means of a slurry feed pump. The solid carbonaceous material may also be provided as a dry feed, such as fluidized or suspended in a gaseous material such as steam, nitrogen, carbon dioxide, or recycled synthesis gas. When the feedstock is liquid or gaseous, no suspending medium or entraining gas is required.

Fluid hydrocarbonaceous fuels and solid carbonaceous materials may be used separately or together and may be combined with any other material. Other material which can be added as feedstock includes any other organic compounds including, among others, solid waste material such as garbage and beneficiated garbage, or other carbon-containing materials. When carbonaceous feedstock without hydrogen is used, a source of hydrogen, like water or steam, can be added as feedstock for the partial oxidation reaction.

Some or all of the feedstock contains slag-depositing material, i.e., one or more elements or compounds which under partial oxidation reaction conditions make solid slag which can collect in the partial oxidation reactor. The slag-depositing material in the feedstock typically is present as impurity or contaminant. The slag-depositing material can vary depending on the feedstock and source of its impurities. Typically, slag-depositing material is mainly the non(hydro)carbonaceous part of the feedstock, i.e., the elements and compounds other than only carbon or hydrocarbons containing only hydrogen and carbon. The slag-depositing material also comprises unconverted or incompletely converted carbonaceous feedstock to the extent hydrogen and/or especially carbon is present in slag deposits. The slag-depositing material has a slagging component which is an element or compound which, alone or in combination with other material in the reactor, e.g., oxygen or sulfur, forms slag in the partial oxidation reactor. Typical slagging elements include, among others, one or mixtures of the following: transition metals, such as vanadium, iron, nickel, tantalum, tungsten, chromium, manganese, zinc, cadmium, molybdenum, copper, cobalt, platinum, or palladium; alkali or alkali earth metals, such as sodium, potassium, magnesium, calcium, strontium, or barium; and others including aluminum, silicon, phosphorus, germanium, gallium; and the like.

Molecular oxygen-containing gas may be any gas containing oxygen in a form suitable for reaction during the partial oxidation process. Examples of molecular oxygen-containing gases include air; oxygen-enriched air, e.g., air containing greater than 21 mole percent oxygen; substantially pure oxygen, e.g., oxygen consisting of greater than 95 mole percent oxygen. Commonly, the molecular oxygen-containing gas contains oxygen plus other gases derived from the air from which oxygen is prepared, such as for example, nitrogen, argon or other inert gases.

Other materials may optionally be added to the gasification feedstock or process. Any suitable additives may be provided, such as fluxing or washing agents, temperature moderators, stabilizers, viscosity reducing agents, purging agents, inert gases or other useful materials.

The proportion of feedstock to molecular oxygen-containing gas, as well as any optional components, may be any amount effective to make syngas. Typically, the atomic ratio of oxygen, in the molecular oxygen-containing gas, to carbon, in the feedstock, is from 0.6 to about 1.6, preferably from about 0.8 to about 1.4. When the molecular oxygen-containing gas is substantially pure oxygen, the ratio may be from about 0.7 to about 1.5, preferably about 0.9. When the molecular oxygen-containing gas is air, the ratio may be from about 0.8 to about 1.6, preferably about 1.3. When water or other temperature moderator is used, the weight ratio of temperature moderator to carbon in the feedstock may range up to 2, preferably from about 0.2 to about 0.9, and most preferably about 0.5. The relative proportions of feedstock, oxygen, and any water or other temperature moderator in the feedstreams are carefully regulated to derivatize a substantial portion of the carbon in the feedstock, generally at single pass conversion rates of from about 75 to substantially 100, and preferably from about 85 to about 98, weight percent of the carbon to carbon oxides, e.g., carbon monoxide and carbon dioxide, and maintain a suitable autogenous reaction zone temperature.

The charge, including feedstock, molecular oxygen-containing gas and any other materials such as the recovered carbon, typically is delivered to the partial oxidation reactor. Any effective means may be used to feed the feedstock into the reactor. Generally, the feedstock, recovered carbon and gas are added through one or more inlets or openings in the reactor. Typically, the feedstock and gas are passed to a process feed injector which is located in the reactor inlet. Any effective feed injector design may be used to assist the addition or interaction of feedstock and gas in the reactor, such as an annulus-type burner described in U.S. Pat. No. 2,928,460, U.S. Pat. No. 4,328,006, or U.S. Pat. No. 4,328,008. Alternatively, the feedstock and recovered carbon may be introduced into the upper section or top of the reactor through a port. Molecular oxygen-containing gas is typically introduced at high velocity into the reactor through either the burner or a separate port which discharges the oxygen gas directly into the feedstock stream. By this arrangement the charge materials are intimately mixed within the reaction zone and the oxygen gas stream is prevented from directly impinging on and damaging the reactor walls.

The design of the partial oxidation reactor is not a critical aspect of the present invention and may be selected from any of the various known designs. Typically, a vertical, cylindrically shaped, steel pressure vessel can be used. Illustrative reactors and related apparatus are disclosed in U.S. Pat. No. 2,809,104. U.S. Pat. No. 2,818,326, U.S. Pat. No. 3,544,291, U.S. Pat. No. 4,637,82, U.S. Pat. No. 4,653,677, U.S. Pat. No. 4,872,886, U.S. Pat. No. 4,456,546, U.S. Pat. No. 4,671,806, U.S. Pat. No. 4,760,667, U.S. Pat. No. 4,146,370, U.S. Pat. No. 4,823,741, U.S. Pat. No. 4,889,540, U.S. Pat. No. 4,959,080, U.S. Pat. No. 4,979,964 and U.S. Pat. No. 6,706,199. The reaction zone preferably comprises a downflowing, free-flow, refractory-lined chamber with a centrally located inlet at the top and an axially aligned outlet in the bottom.

The refractory may be any effective material for a partial oxidation reactor. The refractory may be prefabricated and installed, such as fire brick material, or may be formed in the reactor, such as plastic ceramic. Examples of refractory include one or mixtures of metal oxides, e.g., chromium oxide, magnesium oxide, ferrous oxide, aluminum oxide, calcium oxide, silica, zirconia, and titania; phosphorus compounds; and the like. The relative amount of refractory materials may be any effective proportion.

The partial oxidation reaction involved in the present invention may be carried out at or under any conditions known for converting carbonaceous feedstock to syngas. Reaction temperatures typically range from about 900 to 2,000° C., preferably from about 1,200 to 1500° C. Reaction pressures typically range from about 1 to 250, preferably from about 10 to 200, atmospheres. The average residence time in the reaction zone generally ranges from about 0.5 to 20 seconds, and more typically from about 1 to 10, seconds.

The partial oxidation reaction is conducted under highly reducing conditions for syngas production. Normally, the concentration of molecular oxygen in the reactor, calculated in terms of partial pressure, during partial oxidation is less than about 10⁻⁵, more typically from about 10⁻¹² to 10⁻⁸, atmospheres. Once the charge materials enter the reactor, incomplete combustion takes place in the reaction chamber to make a product stream comprising hydrogen, carbon monoxide, steam, and carbon dioxide. Other gases often present include hydrogen sulfide, carbonyl sulfide, methane, ammonia, nitrogen, volatile metals, and other inert gases such as argon.

The product leaving the reactor contains non-gaseous by-products which vary in amount and type depending upon the feedstock composition. The non-gaseous by-product is typically particulates, generally carbon and inorganic ash. Much of the non-gaseous by-product is entrained in the product stream and carried out of the reactor. Some of the non-gaseous by-product contacts the inside surfaces of the reactor and may stick to the surface as slag. Slag comprises fused mineral matter, i.e. ash, by-product of the slag-depositing material in the feedstock, unconverted or incompletely converted carbonaceous feedstock, flyash and soot.

Slag composition will vary depending on the type of slag-depositing material in the feedstock, reaction conditions and other factors influencing slag deposition. Typically, the ash component of the slag comprises oxides and sulfides of slagging elements. For example, slag made from impure coke or resid usually contains siliceous material, like glass and crystalline structures such as wollastinite, gehlenite and anorthite; vanadium oxide, generally in a reduced state like the trivalent vanadium trioxide; spinel, such as having a composition represented by the formula AB₂O₄ wherein A is iron and magnesium and B is aluminum, vanadium and chromium; sulfides of iron and/or nickel; and metallic iron and nickel. Slag having a melting point below the temperature in the reactor, can melt and flow out the reactor, such as through outlet located at the bottom of the reactor, as molten slag.

The gas product, molten slag, or other by-product which flows out of the reactor may be processed by any effective, including known, manner. Product stream leaving the reaction zone is generally cooled, by any suitable procedures, including known procedures such as described in the previously noted patents, to any desired temperature to assist product stream processing and handling. Typically, the product stream is cooled directly and/or indirectly, such as by quenching or radiant/convective cooling. In direct cooling by quenching, the product gas is cooled or quenched in a quench vessel, preferably located directly below the reactor vessel, generally by bubbling the product stream through aqueous liquid in the quench vessel. In radiant or indirect cooling, the product stream leaves the reaction zone and enters a radiant or convective cooler, such as through heat exchange surface made up of a series of connected tubes containing water or steam.

The cooled syngas exits the gasification zone and is then subjected to a series of cleaning processes, including sulfur removal, before being used to produce a useful end product such as electricity or industrial chemicals. As an alternative to water cooling in a quench chamber, a syngas cooler, or similar device for cooling hot gases may be used. The syngas cooling device need not recover heat/energy for reuse in the gasifier reaction chamber. Less efficient gas coolers simply expel excess heat into the atmosphere or into a reservoir.

Nongaseous by-product, such as molten slag, which flows out of the reactor may be collected in a quench chamber or slag pot. Slag which collects in a quench chamber or other pressurized vessel can be discharged to a lockhopper or other container.

The slag leaving the reactor may be collected by any effective means. For example, slag can be retained in a quench or cooling vessel below the reactor outlet or in a slag sump, meaning a vessel for receiving slag directly or indirectly from a reactor outlet. Typically, slag is collected in the quench or cooling vessel and periodically discharged into a slag sump or lockhopper. The slag is collected as a water slurry in a slag sump and may contain components that may alter the pH of the water. A neutralizing agent may be provided, either directly to the water or indirectly such as part of the gasification charge, to maintain moderate pH levels in the slag waters.

In accordance with step (1) of the present invention, a water slurry of the solid slag effluent from the gasification zone is fed to and passed over a vibrating screen device designed and operated to produce a first solid product having an average particle size of greater than about 850 microns and a water slurry of a second solid product having an average particle size of less than about 849 microns. Normally the water slurry of the slag is pumped to the vibrating screen device. The slurry typically contains at least 5 weight percent and as much as 60 weight percent solid slag, more typically about 20 to 40 weight percent solid slag. To assist in keeping the slag and unconverted carbon in suspension, recycle water may be added separately, or part of the pump flow can be routed back to the sump. The vibrating screen device is equipped with a suitable screen such as, but not limited to, ASTM E11-87 20 Sieve screen constructed of stainless steel. To aid in separation water sprays may be added to spray onto the screen to separate the under size material from the top size at a rate of about 0.01 to 1 volumes water per volume of the slag slurry fed to the vibrating screen device. The vibrating screen device separates slag particles having an average particle size of greater than about 850 microns. These particles typically are vitreous, glass-line particles high in inorganic mineral content and low in carbon content. Such particles are collected by conventional means for use or disposal. A typical type of screen is Model UP supplied by FMC Technologies.

The first step of our invention produces a water slurry of a second solid product having an average particle size of less than about 850 microns. This water slurry that passes through the vibrating screen device typically comprises at least 10 weight percent solids, more typically from about 20 to 35 weight percent solids based on the weight of the slurry. In the second step of the process, the water slurry of slag particles having an average particle size of less than about 850 microns is transferred to a second separation device via a feed tank to provide a consistent supply of slurry for operation of the separation device. The second separation device preferably is a hydrocyclone separation device that is designed and operated in a manner to produce (1) an overflow water slurry stream of solids comprising particles having an average particle size of less than about 150 microns and (2) an underflow water slurry stream of solids comprising particles having an average particle size of about 150 to 850 microns. Such a hydrocyclone is described by Krebs Engineers gMAX Series literature. Operation of the hydrocyclone separator produces an overflow water slurry stream of solids comprising particles having an average particle size of less than about 150 microns and an underflow water slurry stream of solids comprising particles having an average particle size of about 150 to 850 microns. The particles having an average particle size of less than about 150 microns comprise mainly fine ash with up to 20% carbon. This material is sent to a surge tank and pumped back into the existing process water system. The surge tank is required to control the hydrodynamics of the hydrocyclones.

The solids present in the hydrocyclone underflow comprise approximately 60 to 70% carbon with the remainder sulfur and ash. The hydrocyclone underflow slurry is transferred to a holding tank in order to provide a more consistent slurry to feed to the gasification zone, i.e., the gasifier. The hydrocyclone underflow slurry preferably is fed to the gasification zone via a grinding device wherein a mixture of solid carbonaceous fuel, preferably coal, and water are subjected to grinding to produce a water slurry of the solid carbonaceous fuel having an average particle size of less than about 2.36 mm, typically a particle size of about 0.425 to 0.045 mm, to produce a mixture of the water slurry stream (2) produced in step (2) and the water slurry of the solid carbonaceous fuel. The slurry is transferred, e.g., by pumping, from the agitated feed tank, to the grinding device. The resulting aqueous slurry of fresh feedstock particles and hydrocyclone underflow particles are fed to the gasification zone whereby carbon values present in the gasification slag effluent are recovered. The recycle slurry stream preferably provides about 75 to 100 weight percent of the water employed in the preparation of the slurry fed to the gasifier.

### EXAMPLE

The operation of the process provided by the present invention is further illustrated by the following example utilizing the process flow diagram of the accompanying FIGURE. Central Appalachian Coal is the feedstock used in the example. All percentages given in the example are by weight unless otherwise specified.

Feedstock coal and water are fed to grinding mill 10 via conduits 11 and 12, respectively. A slurry of recovered carbon values also is fed to grinding mill 10 via conduit 13. The particle size of the feedstock coal is reduced to less than about 3 mm in the grinding mill. The slurry of coal and recycled carbon values is fed via conduit 14, along with substantially pure oxygen provide by conduit 15, to gasification zone 20 consisting of partial oxidation reactor zone 21, quench zone 22, lockhopper zone 23 and gasification slag effluent sump 24. Water is fed via conduit 25 to quench zone 22 to cool the slag effluent and product syngas which is removed from gasification zone 20 via conduit 26. A mixture of solid slag effluent and water is transferred though lockhopper zone 23 to sump 24. A water slurry of effluent slag is transferred continuously via conduit 27 to vibrating screen device 30 at the rate of 37850 liters (10,000 gallons US) per hour. Water also is fed to vibrating screen device 30 via conduit 28 at a rate of about 2271 liters (600 gallons US) per hour. A first solid product having an average particle size of greater than about 850 microns is collected by vibrating screen device 30 and removed from the system by conduit 31 at a rate of about 2268 kg (5000 pounds) per hour.

A water slurry of a second solid product having an average particle size of less than about 850 microns passes through vibrating screen device 30 and is transferred to hydrocyclone feed tank 40 by conduit 32 at a rate of about 37850 liters (10,000 gallons US) per hour. Hydrocyclone feed tank 40 is equipped with means for agitation and flow control. The slurry contained in hydrocyclone feed tank 40 is fed via conduit 41 to the upper section of hydrocyclone separation device 50 at a rate of about 37850 liters (10,000 gallons US) per hour via a pump (not shown). Hydrocyclone 50 is designed and operated in a manner to produce (1) an overflow water slurry stream of solids comprising particles having an average particle size of less than about 150 microns and (2) an underflow water slurry stream of solids comprising particles having an average particle size of about 150 to 850 microns. Overflow water slurry (1) is removed from the recovery system by conduit 51 at a rate of about 7,000 gallons per hour. The stream passes through conduit 51 into a surge tank (not shown) and is pumped into an auxiliary water treatment section (not shown) wherein the finer material, e.g. solids having an average particle size of less than about 150 microns may be removed via gravity settling and a filter press. Underflow water slurry (2) is removed from the base of hydrocyclone 50 and transferred to recycle tank 60 via conduit 52. Recycle tank 60 and tank 40 are equipped with means for agitation and flow control. The slurry contained in recycle tank 60 is transferred via pump (not shown) to grinding mill 10 via conduit 13. Tanks 40 and 60 provide means for a constant supply of slurry to hydrocyclone separation device 50 and grinding mill 10 which allows precise control on the gasification slurry solid loading. If necessary, on or more surfactants or pH adjustors may be added in tank 60 via line 53 to improve slurry viscosity.

The solids content (weight percent based on the total weight of the slurry) of some of the slurry streams and range of particle sizes (microns) of the solids component of the slurry in shown in the following Table.

TABLE

| | Solids | Particle Size |
|---|---|---|
| Conduit | Content | (micron) |
| 13 | 35 | 150-850 |
| 27 | 20 | 2-25,400 |
| 41 | 13 | 2-850 |
| 51 | 5 | 1-150 |

The invention has been described in detail with particular reference to preferred embodiments thereof, but it will be understood that variations and modifications can be effected within the spirit and scope of the invention.

We claim:

1. Process for the recovery of carbon values from the solid effluent obtained from a gasification process wherein a carbonaceous fuel is partially oxidized in a gasification zone at elevated temperature and pressure operated in the slagging mode to produce (i) a gaseous product stream comprising carbon monoxide and (ii) a solid slag effluent comprising ash and unconverted carbon, which recovery process comprises the step of:
(1) feeding a slurry of the solid effluent, obtained directly from the gasification process, in water to a vibrating screen device designed and operated to produce a first solid product having an average particle size of greater than about 850 microns and a water slurry of a second solid product having an average particle size of less than about 850 microns.
(2) feeding the water slurry of the second solid product produced in step (1) to a separation device to produce (1) a water slurry stream of solids comprising particles having an average particle size of less than about 150 microns and (2) a water slurry stream of solids comprising particles having an average particle size of about 150 to 850 microns; and
(3) feeding water slurry stream (2) produced in step (2) to the gasification zone.

2. Process according to claim 1 wherein the carbonaceous fuel is coal or petroleum residue.

3. Process according to claim 2 wherein step (1) includes a water spray, at a rate of about 0.01 to 1 volumes water per volume of slag slurry fed to the vibrating screen device, onto the vibrating screen device to separate under size material from top size material.

4. Process for the recovery of carbon values from the solid effluent obtained from a gasification process wherein a solid carbonaceous fuel is partially oxidized in a gasification zone at elevated temperature and pressure operated in the slagging mode to produce (i) a gaseous product stream comprising carbon monoxide and (ii) a solid slag effluent comprising ash and unconverted carbon, which recovery process comprises the step of:
(1) feeding a slurry of the solid effluent, obtained directly from the gasification process, in water to a vibrating screen device designed and operated to produce a first solid product having an average particle size of greater than about 850 microns and a water slurry of a second solid product having an average particle size of less than about 850 microns.
(2) feeding the water slurry of the second solid product produced in step (1) to a hydrocyclone separation device to produce (1) an overflow water slurry stream of solids comprising particles having an average particle size of less than about 150 microns and (2) an underflow water slurry stream of solids comprising particles having an average particle size of about 150 to 850 microns; and
(3) feeding underflow water slurry stream (2) produced in step (2) to the gasification zone.

5. Process according to claim 4 wherein the solid carbonaceous fuel is coal or petroleum residue and step (1) includes a water spray at a rate of about 0.01 to 1 volumes water per volume of slag slurry fed to the vibrating screen device onto the vibrating screen device to separate under size material from top size material.

6. Process for the recovery of carbon values from the solid effluent obtained from a gasification process wherein a solid carbonaceous fuel is partially oxidized in a gasification zone at elevated temperature and pressure operated in the slagging mode to produce (i) a gaseous product stream comprising carbon monoxide and (ii) a solid slag effluent comprising ash and unconverted carbon, which recovery process comprises the step of:
(1) feeding a slurry of the solid effluent, obtained directly from the gasification process, in water to a vibrating screen device designed and operated to produce a first solid product having an average particle size of greater than about 850 microns and a water slurry of a second solid product having an average particle size of less than about 850 microns
(2) feeding the water slurry of the second solid product produced in step (1) to a hydrocyclone separation device to produce (1) an overflow water slurry stream of solids comprising particles having an average particle size of less than about 150 microns and (2) an underflow water slurry stream of solids comprising particles having an average particle size of about 150 to 850 microns; and
(3) (i) feeding water slurry stream (2) produced in step (2) to a grinding device wherein a mixture of solid carbonaceous fuel and water are subjected to grinding to produce a water slurry of the solid carbonaceous fuel having an average particle size of less than about 2.36 mm to produce a mixture of the water slurry stream (2) produced in step (2) and the water slurry of the solid carbonaceous fuel; and
(ii) feeding the mixture produced in step (3) (i) to the gasification zone.

7. Process according to claim 6 wherein the solid carbonaceous fuel is coal or petroleum residue and step (1) includes a water spray at a rate of about 0.01 to 1 volumes water per volume of slag slurry fed to the vibrating screen device onto the vibrating screen device to separate under size material from top size material.

8. Process according to claim 7 wherein water slurry stream (2) produced in step (2) provides about 75 to 100 weight percent of the water present in the mixture produced in step (3) (i) and fed to the gasification zone.
